(19) United States
(12) Patent Application Publication
(10) Pub. No.: US 2025/0333547 A1
(43) Pub. Date: Oct. 30, 2025

(54) MULTI STAGE PROCESS FOR PRODUCING ETHYLENE-BASED POLYMER WITH (ULTRA) HIGH MOLECULAR WEIGHT POLYETHYLENE COMPONENT

(71) Applicant: Dow Global Technologies LLC, Midland, MI (US)

(72) Inventors: Ronald Wevers, Terneuzen (NL); Johan Bats, Terneuzen (NL); Frederik ter Borg, Terneuzen (NL); Cornelis F.J. Den Doelder, Terneuzen (NL)

(73) Assignee: Dow Global Technologies LLC, Midland, MI (US)

(21) Appl. No.: 19/115,005

(22) PCT Filed: Sep. 26, 2023
(86) PCT No.: PCT/US2023/075069

§ 371 Date: Mar. 25, 2025

Related U.S. Application Data
(60) Provisional application No. 63/409,941, filed on Sep. 26, 2022.

(51) Int. Cl. C08F 2/00; C08F 2/01; C08F 2/06; C08F 4/64; C08F 210/14; C08F 210/16

(52) U.S. Cl. CPC C08F 2/001; C08F 2/01; C08F 2/06; C08F 4/64193; C08F 210/14; C08F 210/16; C08F 2410/05

(57) ABSTRACT

Embodiments of methods of producing ethylene-based polymer comprising first and second polymer fractions includes reacting ethylene monomer and optionally C₃-C₁₂ α-olefin comonomer in solvent in the presence of a first catalyst in at least one initial reactor to produce the first polymer fraction reaching an exit temperature of this reaction zone below 160° C., wherein the weight averaged molecular weight (Mw) of this first polymer fraction is larger than 500,000 g/mol; introducing the first polymer fraction, ethylene monomer, optionally C₃-C₁₂ α-olefin comonomer, solvent, at least one second catalyst to at least one agitated solution polymerization reactor; and reacting the ethylene monomer and optionally C₃-C₁₂ α-olefin comonomer in solvent in the presence of the at least one second catalyst in the at least one agitated solution polymerization reactor to produce a second polymer fraction.

### CROSS-REFERENCE TO RELATED APPLICATIONS

This application claims the benefit of U.S. Provisional Application Ser. No. 63/409,941 filed Sep. 26, 2022, the entire disclosure of which is hereby incorporated herein by reference.

### TECHNICAL FIELD

The present specification generally relates to processes of making ethylene-based polymer, and in particular, methods of making ethylene based polymer comprising an ultrahigh molecular weight component.

### BACKGROUND

To improve toughness and processibility of ethylene-based polymer (e.g., LLDPE), (ultra) high molecular weight polyethylene (UHWMPE) material may be added to ethylene-based polymer. Currently, UHMWPE is produced using heterogenous catalysts, in slurry phase or gas phase. Adding UHMWPE conventionally via blending results in relatively large UHMWPE particles, consisting of highly entangled macromolecules. Incorporation of these entangled clusters of UHMWPE in the molecular structure of an ethylene-based polymer is difficult because of the extreme viscosity differences. Specifically, the UHMWPE may have a melt index (I₂) of less than 0.01, whereas the bulk resin (e.g., LLDPE) may have a melt index at least a hundred times greater than that. Thus, there is a continual need for processes to better incorporate UHMWPE into ethylene-based polymers, such as LLDPE.

### SUMMARY

Embodiments of the present disclosure meet this need for improved UHWMPE incorporation by producing UHMWPE in solution at low to moderate reaction temperatures, wherein the catalyst used is not for particle formation (as in slurry or gas phase technology), but aims at producing UHMWPE chains which are evenly dispersed either dissolved or as fine mist (very fine phase separated) in the solvent. In the subsequent solution process conditions the dissolved or dispersed UHMWPE will be solution blended with the ethylene-based polymer. This results in a highly dis-entangled UHMWPE fraction in solution, which is easily incorporated in the downstream solution reactor used to produce the ethylene-based polymer.

According to one embodiment, a method of producing ethylene-based polymer comprising first and second polymer fractions is provided. The method comprises: reacting ethylene monomer and optionally C₃-C₁₂ α-olefin comonomer in solvent in the presence of a first catalyst in at least one initial reactor to produce the first polymer fraction reaching an exit temperature of this reaction zone below 160° C., wherein the weight averaged molecular weight (Mw) of this first polymer fraction is larger than 500,000 g/mol; introducing the first polymer fraction, ethylene monomer, optionally C₃-C₁₂ α-olefin comonomer, solvent, at least one second catalyst to at least one agitated solution polymerization reactor; reacting the ethylene monomer and optionally C₃-C₁₂ α-olefin comonomer in solvent in the presence of the at least one second catalyst in the at least one agitated solution polymerization reactor to produce a second polymer fraction; and outputting effluent from the agitated solution polymerization reactor, wherein the effluent comprises the ethylene-based polymer having the first and second polymer fractions, unreacted ethylene monomer, and optionally unreacted C₃-C₁₂ α-olefin comonomer. The ethylene-based polymer comprises 0.1 to 15 wt. % of the first polymer fraction and more than 70 wt. % of the second polymer fraction. Furthermore, the ethylene-based polymer has a melt index (I₂) from 0.1 to 50 g/10 mins., a density between 0.870 to 0.970 g/cc and has an Mz/Mw greater than the Mw/Mn.

Additional features and advantages will be set forth in the detailed description which follows, and in part will be readily apparent to those skilled in the art from that description or recognized by practicing the embodiments described herein, including the drawings, the detailed description which follows and the claims.

### BRIEF DESCRIPTION OF THE DRAWINGS

FIG. 1 is a schematic view of the present process according to one or more embodiments of the present disclosure;

FIG. 2 is another schematic view of the present process according to one or more embodiments of the present disclosure;

FIG. 3 is yet another schematic view of the present process according to one or more embodiments of the present disclosure;

FIG. 4 is a graphical plot of I₁₀/I₂ versus I₂ for experimental samples according to one or more embodiments of the present disclosure;

FIG. 5 is a graphical plot of Melt Strength versus Dynamic Melt Viscosity for experimental samples according to one or more embodiments of the present disclosure; and

FIGS. 6A and 6B is a graphical plot of the Uniaxial Stress Growth Coefficient over time for experimental samples according to one or more embodiments of the present disclosure.

### DETAILED DESCRIPTION

Specific embodiments of the present application will now be described. The disclosure may, however, be embodied in different forms and should not be construed as limited to the embodiments set forth in this disclosure. Rather, these embodiments are provided so that this disclosure will be thorough and complete, and will fully convey the scope of the subject matter to those skilled in the art.

### Definitions

The term “polymer” refers to a polymeric compound prepared by polymerizing monomers, whether of the same or a different type. The generic term polymer thus embraces the term “homopolymer,” usually employed to refer to polymers prepared from only one type of monomer as well as “copolymer” which refers to polymers prepared from two or more different monomers. The term “interpolymer,” as used herein, refers to a polymer prepared by the polymerization of at least two different types of monomers. The generic term interpolymer thus includes copolymers, and polymers prepared from more than two different types of monomers, such as terpolymers.

“Polyethylene” or “ethylene based polymer” shall mean polymers comprising greater than 50% by weight of units which have been derived from ethylene monomer. This includes polyethylene homopolymers or copolymers (meaning units derived from two or more comonomers). Comonomers may include olefin comonomers as well as polar comonomers. Common forms of polyethylene known in the art include Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE).

The term “LDPE” may also be referred to as “high pressure ethylene polymer” or “highly branched polyethylene” and is defined to mean that the polymer is partly or entirely homopolymerized or copolymerized in autoclave or tubular reactors at pressures above 14,500 psi (100 MPa) with the use of free-radical initiators, such as peroxides (see for example U.S. Pat. No. 4,599,392, which is hereby incorporated by reference). LDPE resins typically have a density in the range of 0.916 grams per cubic centimeter (g/cc) to 0.935 g/cc.

The term “LLDPE”, includes resin made using Ziegler-Natta catalyst systems as well as resin made using single-site catalysts, including, but not limited to, bis-metallocene catalysts (sometimes referred to as “m-LLDPE”) and constrained geometry catalysts, and resin made using post-metallocene, molecular catalysts. LLDPE includes linear, substantially linear or heterogeneous polyethylene copolymers or homopolymers. LLDPEs contain less long chain branching than LDPEs and includes the substantially linear ethylene polymers which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or 5,854,045). The LLDPE resins can be made via gas-phase, solution-phase or slurry polymerization or any combination thereof, using any type of reactor or reactor configuration known in the art.

The term “MDPE” refers to polyethylenes having densities from 0.926 to 0.940 g/cc. “MDPE” is typically made using chromium or Ziegler-Natta catalysts or using single-site catalysts including, but not limited to, bis-metallocene catalysts and constrained geometry catalysts.

The term “HDPE” refers to polyethylenes having densities greater than about 0.940 g/cc, which are generally prepared with Ziegler-Natta catalysts, chrome catalysts or single-site catalysts including, but not limited to, bis-metallocene catalysts and constrained geometry catalysts.

The term “UHMWPE” refers to polyethylenes having weight average molecular weight (Mw) greater than 500,000 g/mol as measured according to conventional Gel Permeation Chromatography.

The term “disentangled network” refers to a polymer wherein the chains are less interconnected, thereby allowing increased flow, processibility, and drawability. In contrast, the term “entangled network” refers to a polymer wherein the chains are highly interconnected, thereby reducing flow, processibility, and drawability

As used in the present disclosure, the terms “blend” or “polymer blend,” as used, refer to a mixture of two or more polymers. A blend may or may not be miscible (phase separated at the molecular level). A blend may or may not be phase separated. A blend may or may not contain one or more domain configurations, as determined from transmission electron spectroscopy, light scattering, x-ray scattering, and other methods known in the art. The blend may be prepared by physically mixing the two or more polymers on the macro level (for example, melt blending resins or compounding) or the micro level (for example, simultaneous forming within the same reactor). It is possible to prepare the blends in a melt phase or using solution blending in a common solvent.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

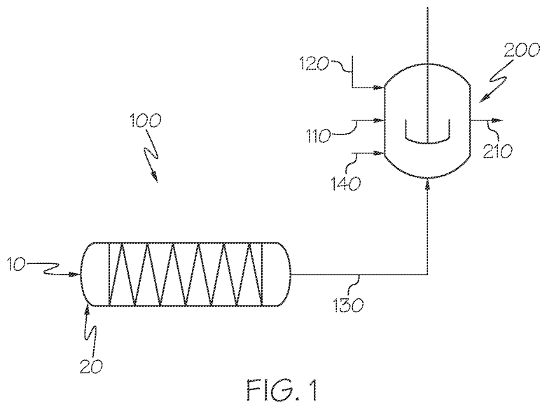

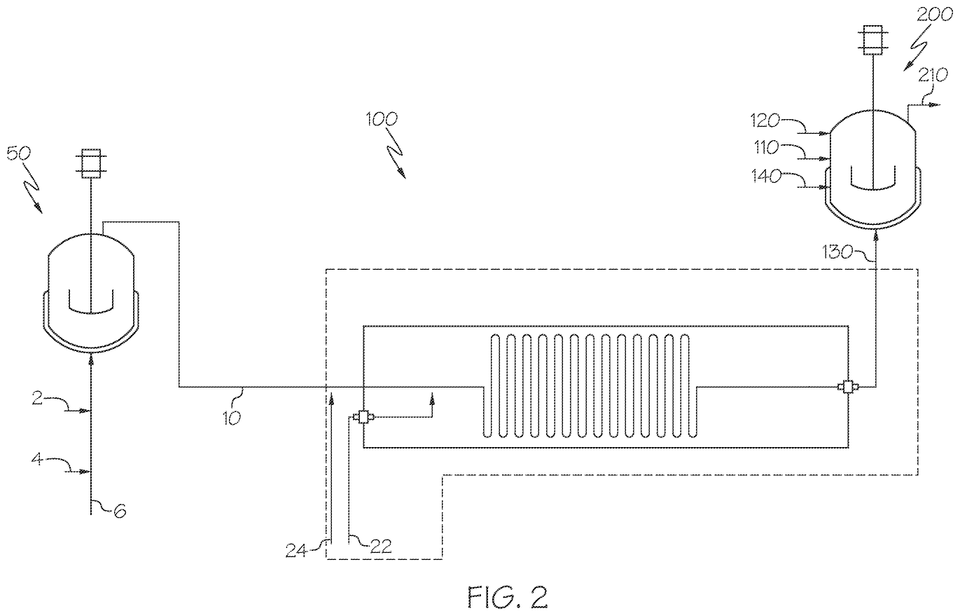

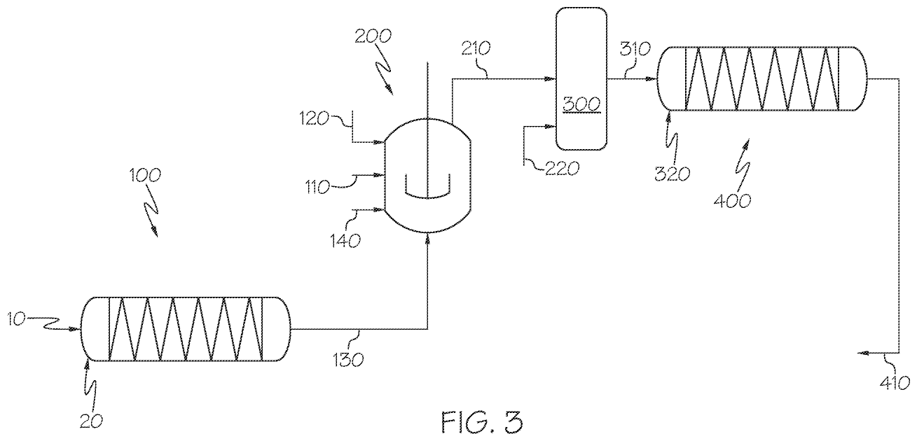

Embodiments of the present disclosure are directed to systems and methods for producing ethylene-based polymer comprising first and second polymer fractions. The first polymer fraction may also be referred to herein as the high molecular weight fraction or the “HMW fraction”, whereas the second polymer fraction may also be referred to herein as the “bulk fraction.” Referring to FIGS. 1 and 3, the method comprises reacting ethylene monomer and optionally C₃-C₁₂ α-olefin comonomer in solvent 10 in the presence of a first catalyst 20 in at least one initial reactor 100 to produce a first polymer fraction 130 reaching an exit temperature of this reaction zone below 160° C., wherein the weight averaged molecular weight (Mw) of this first polymer fraction is larger than 500,000 g/mol. The first polymer fraction may also be considered the UHMWPE fraction. Various means for supplying the monomer, solvent and catalyst are considered suitable. In another embodiment as shown in FIG. 2, ethylene 2, C₃-C₁₂ α-olefin comonomer 4, and solvent 6 may mix in a mixing vessel 50 upstream of the initial reactor 100. While FIG. 2 depicts the mixing vessel 50 as a continuous stirred tank reactor (CSTR), various additional mixing containers are considered suitable. Further as shown in FIG. 2, the procatalyst 22 and cocatalyst 24 may be fed separately as shown, or alternatively as shown in FIG. 1 catalyst may be fed in a single stream 20.

In one or more embodiments, the initial reactor 100 may comprise a tubular reactor, such as a tubular plug flow reactor. Moreover, as stated above, the exit temperature may be less than 160° C., or less than 157° C. Further, the exit temperature may be from 60 to 160° C., or from 60 to 90° C., or from 80 to 110° C., or from or from 120 to 160° C., or from 120 to 145° C. or from 130 to 155° C., 140 to 160° C. Pressures may range from about 400 to about 1000 psi, or from about 650 to about 800 psi. The residence time may be from about 0.5 to about 15 minutes, or from about 0.5 to about 2 minutes. In other embodiment, the initial reactor (such as a tubular reactor) may be operated at adiabatic conditions. In other embodiment, the initial reactor (such as a tubular reactor) reactor may be operated with cooling, heating, or a combination.

Various solvents are considered suitable. Exemplary solvents include, but are not limited to, isoparaffins. For example, such solvents are commercially available under the name ISOPAR E (ExxonMobil Chemical Co., Houston, Tex.).

Within the first fraction, the ethylene monomer may be present in an amount of at least 50 wt. %, or at least 60 wt. %, or at least 70 wt. %, or at least 80 wt. %. Conversely, the C₃-C₁₂ α-olefin comonomer may be present in the first fraction at an amount of at less than 50 wt. %, or less than 40 wt. %, or less than 30 wt. %, or less than 20 wt. %.

The first catalyst may comprise at least one molecular catalyst, at least one heterogeneous Ziegler-Natta catalyst, or combinations thereof. Constrained geometry and metallocene catalysts are also contemplated as suitable. In one embodiment, the first catalyst comprises a molecular catalyst. The molecular catalyst may comprise one or more bis-biphenyl-phenoxy catalysts. Without being bound by theory, using a molecular homogeneous catalyst in a temperature regime less than 160° C. helps create a UHMWPE first fraction in a phase separated mode which can be better incorporated into the second polymer fraction produced in the downstream agitated solution polymerization reaction as defined further below. Further without being bound by theory, constrained crystallization of these UHMWPE chains gives the potential to modify performance characteristics of the overall polymer.

The first polymer fraction may comprise a weight averaged molecular weight (Mw) greater than 500,000 g/mol, greater than 750,000 g/mol, or greater than 1,000,000 g/mol as measured according to gel permeation chromatography. Additionally, the first polymer fraction may comprise an Mw from 500,000 to 1,500,000 g/mol, from 500,000 to 1,250,000 g/mol, from 500,000 to 1,100,000 g/mol, from 750,000 to 1,500,000 g/mol, from 750,000 to 1,250,000 g/mol, from 750,000 to 1,100,000 g/mol, from 900,000 to 1,500,000 g/mol, from 900,000 to 1,200,000 g/mol, or from 900,000 to 1,100,000 g/mol. Moreover, the first polymer fraction may comprise a number averaged molecular weight (Mn) greater than 250,000 g/mol, or greater than 400,000 g/mol, or greater than 500,000 g/mol as measured according to gel permeation chromatography. Additionally, the first polymer fraction may comprise an Mn from 250,000 to 750,000 g/mol, from 250,000 to 600,000 g/mol, from 400,000 to 750,000 g/mol, or from 400,000 to 600,000 g/mol. Furthermore, the first polymer fraction may have an MWD (=Mw/Mn) from 1 to 20, from 1 to 15, from 1 to 10, from 1 to 5, or from 1 to 3.

Moreover, the density of the first polymer fraction may range from 0.870 to 0.920 g/cc, from 0.870 to 0.900 g/cc, or from 0.870 to 0.890 g/cc. The melt index (I₂) may range from 0.0001 to 0.5 dg/min, from 0.0001 to 0.1 dg/min, or 0.0001 to 0.05 dg/min.

Referring to FIGS. 1-3, the first polymer fraction 130, ethylene monomer 110, optionally C₃-C₁₂ α-olefin comonomer 120, solvent, and optionally at least one second catalyst 140 may be fed to at least one agitated solution polymerization reactor 200. In the agitated solution polymerization reactor 200, the ethylene monomer and optionally C₃-C₁₂ α-olefin comonomer react in solvent in the presence of the second catalyst to produce a second polymer fraction.

In one or more embodiments, the agitated solution polymerization reactor 200 may comprise at least one continuous stirred tank reactor (CSTR), at least one loop reactor, or combinations thereof. Moreover, as stated above, the exit temperature may be from about 150 to about 575° C., or from about 175 to about 205° C. Pressures may range from about 30 to about 1000 psi, or from about 30 to about 750 psi. The residence time may be from about 2 to about 20 minutes, or from about 10 to about 20 minutes. In an additional embodiment, the CSTR or Loop Reactor exit is connected to a tubular post reactor, which may reach an exit temperature above 205° C.

Like the upstream initial reactor, various solvents are considered suitable. Exemplary solvents include, but are not limited to, isoparaffins, such as ISOPAR E. In one or more embodiments, the fraction of first polymer in the agitated solution polymerization reactor 200 may be less than 5 wt. %, less than 2 wt. %, less than 1 wt. %.

Within the second polymer fraction, the ethylene monomer may be present in an amount of at least 50 wt. %, or at least 60 wt. %, or at least 70 wt. %, or at least 80 wt. %. Conversely, the C₃-C₁₂ α-olefin comonomer may be present in the second fraction at an amount of at less than 50 wt. %, or less than 40 wt. %, or less than 30 wt. %, or less than 20 wt. %. In one or more embodiments, the second polymer fraction comprises LLDPE.

Various compositions are considered suitable for the second catalyst. In one embodiment, the first catalyst and the second catalyst comprise different compositions. In further embodiments, the second catalyst may comprise at least one molecular catalyst, at least one heterogeneous Ziegler-Natta catalyst, or combinations thereof. Constrained geometry and metallocene catalysts are also contemplated as suitable. In another embodiment, the second catalyst may comprise heterogeneous Ziegler-Natta catalyst.

The second polymer fraction may comprise a weight averaged molecular weight (Mw) greater than 50,000 g/mol, or greater than 75,000 g/mol, or greater than 90,000 g/mol as measured according to gel permeation chromatography. Additionally, the second polymer fraction may comprise an Mw from 50,000 to 120,000 g/mol, from 50,000 to 100,000 g/mol, from 75,000 to 120,000 g/mol, from 75,000 to 100,000 g/mol, or from 90,000 to 120,000 g/mol, from 90,000 to 100,000 g/mol. Moreover, the second polymer fraction may comprise a number averaged molecular weight (Mn) greater than 10,000 g/mol, or greater than 15,000 g/mol as measured according to gel permeation chromatography. Additionally, the second polymer fraction may comprise an Mn from 10,000 to 50,000 g/mol, from 10,000 to 25,000 g/mol, from 15,000 to 50,000 g/mol, or from 15,000 to 25,000 g/mol. Furthermore, the second polymer fraction may have an MWD (=Mw/Mn) from 1 to 20, from 1 to 15, from 1 to 10, from 2 to 5, or from 3 to 5.

Moreover, the density of the second polymer fraction may range from 0.870 to 0.970 g/cc, from 0.870 to 0.940 g/cc, from 0.890 to 0.920 g/cc, or from 0.905 to 0.920 g/cc. The melt index (I₂) may range from 0.1 to 50 dg/min, from 0.1 to 5 dg/min, from 1 to 5 dg/min, or 1 to 3 dg/min.

Referring again to FIGS. 1-3, the effluent 210 outputted from the agitated solution polymerization reactor 200 may comprise the first and second polymer fractions, unreacted ethylene monomer, and optionally unreacted C₃-C₁₂ α-olefin comonomer. The ethylene-based polymer comprises 0.1 to 15 wt. % of the first polymer fraction and more than 70 wt. % of the second polymer fraction. Moreover, the ethylene-based polymer has a melt index (I₂) from 0.1 to 50 g/10 mins., a density between 0.870 to 0.970 g/cc and has an Mz/Mw greater than the Mw/Mn.

In embodiments, the effluent of the agitated solution polymerization reactor 200 may undergo one or separation steps to isolate the ethylene based polymer from the unreacted ethylene monomer and optionally unreacted C₃-C₁₂ α-olefin comonomer.

The ethylene based polymer may comprise a weight averaged molecular weight (Mw) greater than 50,000 g/mol, greater than 50,000 g/mol, or greater than 100,000 g/mol as measured according to gel permeation chromatography. Additionally, the ethylene based polymer may comprise an Mw from 50,000 to 150,000 g/mol, from 50,000 to 120,000 g/mol, from 75,000 to 150,000 g/mol, from 75,000 to 120,000 g/mol, from 90,000 to 150,000 g/mol, or from 90,000 to 120,000 g/mol. Moreover, the ethylene based polymer may comprise a number averaged molecular weight (Mn) greater than 10,000 g/mol, or greater than 15,000 g/mol as measured according to gel permeation chromatography. Additionally, the ethylene based polymer may comprise an Mn from 10,000 to 50,000 g/mol, from 10,000 to 25,000 g/mol, from 15,000 to 50,000 g/mol, or from 15,000 to 25,000 g/mol. The ethylene based polymer may comprise an z-average molecular weight (Mz) of at least 500,000 g/mol, or 750,000 g/mol. The ethylene based polymer may comprise an Mz from 750,000 to 1,000,000 g/mol, or from 800,000 to 900,000 g/mol. Furthermore, the ethylene based polymer may have an Mz/Mw from 1 to 20, from 1 to 15, from 1 to 10, from 5 to 10, or from 5 to 7.

Moreover, the density of the ethylene based polymer may range from 0.870 to 0.970 g/cc, from 0.870 to 0.940 g/cc, from 0.890 to 0.920 g/cc, or from 0.905 to 0.920 g/cc. The melt index (I₂) may range from 0.1 to 50 dg/min, from 0.1 to 25 dg/min, from 0.1 to 10 dg/min, from 0.1 to 5 dg/min, from 0.5 to 50 dg/min, from 0.5 to 25 dg/min, from 0.5 to 5 dg/min, from 0.5 to 2 dg/min, or from 0.5 to 1 dg/min. The ethylene based polymer may have an 110/I₂ from 1 to 30, from 5 to 20, from 5 to 15, from 9 to 15, or from 9 to 12.

Alternatively, as shown in FIGS. 2 and 3, the effluent 210 of the agitated solution polymerization reactor 200 may be passed to a mixer 300 downstream of the agitated solution polymerization reactor 200, wherein the mixer includes the addition of a third catalyst 220. The third catalyst facilitates further reaction of the unreacted ethylene monomer and optionally any unreacted C₃-C₁₂ α-olefin comonomer to produce a third polymer fraction having a density and a melt index (I₂) different from the second polymer fraction.

The third catalyst comprises at least one molecular catalyst, at least one heterogeneous Ziegler-Natta catalyst, or combinations thereof. Constrained geometry and metallocene catalysts are also contemplated as suitable.

In a further embodiment depicted in FIG. 3, the method comprises introducing a mixer effluent 310 from the mixer 300 to a tubular polymerization reactor 400, wherein the mixer effluent 310 comprises the ethylene-based polymer having the first, second and third polymer fractions. While the third catalyst 220 may be already fed in the upstream mixer 300, it is contemplated that a third catalyst or another catalyst may be added to tubular reactor 300 as shown in stream 320.

The ethylene-based polymer is considered suitable for multiple applications. For example, it is considered suitable for films (monolayer and multilayer), fibers, non-woven materials, artificial turf and various articles incorporating these films. For example, the ethylene-based polymer may be used in a variety of films, including but not limited to, extrusion coating, food packaging, consumer, industrial, agricultural (applications or films), lamination films, fresh cut produce films, meat films, cheese films, candy films, clarity shrink films, collation shrink films, stretch films, oriented films (MDO, BOPE), silage films, greenhouse films, fumigation films, liner films, stretch hood, heavy duty shipping sacks, pet food, sandwich bags, sealants, and diaper backsheets.

### TEST METHODS

### Density

Samples for density measurement are prepared according to ASTM D 1928. Polymer samples are pressed at 190° C. and 30,000 psi for three minutes, and then at 21° C. and 207 MPa for one minute. Measurements are made within one hour of sample pressing using ASTM D792, Method B.

### Melt Index (I₂)

Melt index, or I₂, (grams/10 minutes or dg/min) is measured in accordance with ASTM D 1238, Condition 190° C./2.16 kg, Procedure B.

### Melt Strength

Melt strength was measured at 190° C. using a Goettfert Rheotens 71.97 (Goettfert Inc.; Rock Hill, S.C.), melt fed with a Goettfert Rheotester 2000 capillary rheometer equipped with a flat entrance angle (180 degrees) of length of 30 mm and diameter of 2 mm. The pellets were fed into the barrel (L=300 mm, Diameter=12 mm), compressed and allowed to melt for 10 minutes before being extruded at a constant piston speed of 0.265 mm/s, which corresponds to a wall shear rate of 38.2 s⁻¹ at the given die diameter. The extrudate was passed through the wheels of the Rheotens located at 100 mm below the die exit and was pulled by the wheels downward at an acceleration rate of 2.4 mm/s². The force (in cN) exerted on the wheels was recorded as a function of the velocity of the wheels (mm/s). Melt strength was reported as the plateau force (cN) before the strand breaks or has significant draw resonance.

### Dynamic-Mechanical Spectroscopy (DMS)

Melt rheology, frequency scans at constant temperature, was performed using a TA Instruments Advanced Rheometric Expansion System (ARES) rheometer equipped with 25 mm parallel plates under a nitrogen purge. Frequency sweeps were carried out at 190° C. for all samples 2.0 mm apart at a constant tension of 10%. The frequency range was 0.1 to 100 radians/second. The stress response in terms of amplitude and phase was analyzed, from which the storage modulus (G′), loss modulus (G″), and dynamic melt viscosity (n*) were calculated.

### Triple Detector Gel Permeation Chromatography (TDGPC)

The chromatographic system consisted of a PolymerChar GPC-IR (Valencia, Spain) high temperature GPC chromatograph equipped with an internal IR5 infra-red detector (IR5) and 4-capillary viscometer (DV) coupled to a Precision Detectors (Now Agilent Technologies) 2-angle laser light scattering (LS) detector Model 2040. For all Light scattering measurements, the 15 degree angle is used for measurement purposes. The autosampler oven compartment was set at 160° Celsius and the column compartment was set at 150° Celsius. The columns used were 4 Agilent “Mixed A” 30 cm 20-micron linear mixed-bed columns and a 20-um pre-column. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration and calculation of the conventional molecular weight moments and the distribution (using the 20 um “Mixed A” columns) were performed according to the method described in the Conventional GPC procedure.

The Systematic Approach for the determination of multi-detector offsets is done in a manner consistent with that published by Balke, Mourey, et. al. (Mourey and Balke, Chromatography Polym. Chpt 12, (1992)) (Balke, Thitiratsakul, Lew, Cheung, Mourey, Chromatography Polym. Chpt 13, (1992)), optimizing triple detector log (MW and IV) results from a broad homopolymer polyethylene standard (Mw/Mn>3) to the narrow standard column calibration results from the narrow standards calibration curve using PolymerChar GPCOne™ Software. As used herein, “MW” refers to molecular weight.

The absolute molecular weight data was obtained in a manner consistent with that published by Zimm (Zimm, B. H., J. Chem. Phys., 16, 1099 (1948)) and Kratochvil (Kratochvil, P., Classical Light Scattering from Polymer Solutions, Elsevier, Oxford, NY (1987)) using PolymerChar GPCOne™ software. The overall injected concentration, used in the determination of the molecular weight, was obtained from the mass detector area and the mass detector constant, derived from a suitable linear polyethylene homopolymer, or one of the polyethylene standards of known weight-average molecular weight. The calculated molecular weights (using GPCOne™) were obtained using a light scattering constant, derived from one or more of the polyethylene standards mentioned below, and a refractive index concentration coefficient, dn/dc, of 0.104. Generally, the mass detector response (IR5) and the light scattering constant (determined using GPCOne™) should be determined from a linear standard with a molecular weight in excess of about 50,000 g/mole. The viscometer calibration (determined using GPCOne™) can be accomplished using the methods described by the manufacturer, or, alternatively, by using the published values of suitable linear standards, such as Standard Reference Materials (SRM) 1475a (available from National Institute of Standards and Technology (NIST)). A viscometer constant (obtained using GPCOne™) is calculated which relates specific viscosity area (DV) and injected mass for the calibration standard to its intrinsic viscosity (IV). The chromatographic concentrations are assumed low enough to eliminate addressing 2nd viral coefficient effects (concentration effects on molecular weight).

The absolute weight average molecular weight (Mw(Abs)) is obtained (using GPCOne™) from the Area of the Light Scattering (LS) integrated chromatogram (factored by the light scattering constant) divided by the mass recovered from the mass constant and the mass detector (IR5) area. The molecular weight and intrinsic viscosity responses are extrapolated at chromatographic ends where signal to noise becomes low (using GPCOne™) Other respective moments, Mn_{(Abs)} and Mz_{(Abs)} are be calculated according to equations 1-2 as follows:

$${Mn}_{( Abs )} = \frac{{\sum }^{i} {IR}_{i}}{{\sum }^{i} ( {IR}_{i} / {M}_{{Absolute}_{i}} )} \qquad ( EQ 1 )$$

$${Mz}_{( Abs )} = \frac{{\sum }^{i} ( {IR}_{i} ⋆ {M}_{{Absolute}_{i}}^{2} )}{{\sum }^{i} ( {IR}_{i} ⋆ {M}_{{Absolute}_{i}} )} \qquad ( EQ 2 )$$

For conventional GPC, the chromatographic system consisted of a PolymerChar GPC-IR (Valencia, Spain) high temperature GPC chromatograph equipped with an internal IR5 infra-red detector (IR5) coupled to a Precision Detectors (Now Agilent Technologies) 2-angle laser light scattering (LS) detector Model 2040. For all Light scattering measurements, the 15 degree angle is used for measurement purposes. The autosampler oven compartment was set at 160° Celsius and the column compartment was set at 150° Celsius. The columns used were 4 Agilent “Mixed A” 30 cm 20-micron linear mixed-bed columns. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration of the GPC column set was performed with 21 narrow molecular weight distribution polystyrene standards with molecular weights ranging from 580 g/mol to 8,400,000 g/mol and were arranged in 6 “cocktail” mixtures with at least a decade of separation between individual molecular weights. The standards were purchased from Agilent Technologies. The polystyrene standards were prepared at 0.025 grams in 50 milliliters of solvent for molecular weights equal to or greater than 1,000,000 g/mol, and 0.05 grams in 50 milliliters of solvent for molecular weights less than 1,000,000 g/mol. The polystyrene standards were dissolved at 80 degrees Celsius with gentle agitation for 30 minutes. The polystyrene standard peak molecular weights were converted to polyethylene molecular weights using Equation 1 (as described in Williams and Ward, J. Polym. Sci., Polym. Let., 6, 621 (1968)):

$${MW}_{polyethylene} = A \times {( M {w}_{polystyrene} )}^{B} \qquad ( EQ 3 )$$

where MW is the molecular weight, A has a value of 0.4315 and B is equal to 1.0.

A fifth order polynomial was used to fit the respective polyethylene-equivalent calibration points. A small adjustment to A (from approximately 0.395 to 0.440) was made to correct for column resolution and band-broadening effects such that of a linear homopolymer polyethylene standard is obtained at 120,000 g/mol Mw.

The total plate count of the GPC column set was performed with decane (prepared at 0.04 g in 50 milliliters of TCB.) The plate count (Equation 4) and symmetry (Equation 5) were measured on a 200 microliter injection according to the following equations:

$$Plate Count = 5.54 * {( \frac{{RV}_{Peak Max}}{Peak Width at \frac{1}{2} height} )}^{2} \qquad ( EQ 4 )$$

where RV is the retention volume in milliliters, the peak width is in milliliters, the peak max is the maximum height of the peak, and % height is % height of the peak maximum.

$$Symmetry = \frac{( Re ar Peak {R V}_{one tenth height} - R {V}_{Peak max} )}{( {RV}_{Peak max} - Front Peak {RV}_{one tenth height} )} \qquad ( EQ 5 )$$

where RV is the retention volume in milliliters and the peak width is in milliliters, Peak max is the maximum position of the peak, one tenth height is 1/10 height of the peak maximum, and where rear peak refers to the peak tail at later retention volumes than the peak max and where front peak refers to the peak front at earlier retention volumes than the peak max. The plate count for the chromatographic system should be greater than 24,000 and symmetry should be between 0.98 and 1.22.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 2 hours at 160° Celsius under “low speed” shaking.

The calculations of Mn(conv), Mw(conv), and Mz(conv) were based on GPC results using the internal IR5 detector (measurement channel) of the PolymerChar GPC-IR chromatograph according to Equations 6-8, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1.

$$M n ( conv ) = \frac{{\sum }^{i} {IR}_{i}}{{\sum }^{i} ( {IR}_{i} / {M}_{p o {lyethylene}_{i}} )} \qquad ( EQ 6 )$$

$$Mw ( conv ) = \frac{{\sum }^{i} ( {IR}_{i} * {M}_{{polyethylene}_{i}} )}{{\sum }^{i} {IR}_{i}} \qquad ( EQ 7 )$$

$$Mz ( conv ) = \frac{{\sum }^{i} ( {IR}_{i} * {M}_{{polyethylene}_{i}}^{2} )}{{\sum }^{i} ( {IR}_{i} * {M}_{{polyethylene}_{i}} )} \qquad ( EQ 8 )$$

In order to monitor the deviations over time, a flowrate marker (decane) was introduced into each sample via a micropump controlled with the PolymerChar GPC-IR system. This flowrate marker (FM) was used to linearly correct the pump flowrate (Flowrate(nominal)) for each sample by RV alignment of the respective decane peak within the sample (RV(FM Sample)) to that of the decane peak within the narrow standards calibration (RV(FM Calibrated)). Any changes in the time of the decane marker peak are then assumed to be related to a linear-shift in flowrate (Flowrate(effective)) for the entire run. To facilitate the highest accuracy of a RV measurement of the flow marker peak, a least-squares fitting routine is used to fit the peak of the flow marker concentration chromatogram to a quadratic equation. The first derivative of the quadratic equation is then used to solve for the true peak position. After calibrating the system based on a flow marker peak, the effective flowrate (with respect to the narrow standards calibration) is calculated as Equation 9. Processing of the flow marker peak was done via the PolymerChar GPCOne™ Software. Acceptable flowrate correction is such that the effective flowrate should be within +/−2% of the nominal flowrate.

$$Flowrate ( effective ) = Flowrate ( nominal ) ⋆ ( RV ( FM Calibrated ) / RV ( FM Sample ) ) \qquad ( EQ 9 )$$

### GPC Deconvolution

The conventional GPC data was deconvoluted to give the most probable fit for two molecular weight components. There are a number of deconvolution algorithms available both commercially and in the literature. These may lead to different answers depending upon the assumptions used. The algorithm summarized here is optimized for the deconvolution problem of the two most probable molecular weight distributions (plus an adjustable error term). In order to allow for the variations in the underlying distributions due to the macromer incorporation and small fluctuations in the reactor conditions (i.e. temperature, concentration) the basis functions were modified to incorporate a normal distribution term. This term allows the basis function for each component to be “smeared” to varying degrees along the molecular weight axis. The advantage is that in the limit (low LCB, perfect concentration and temperature control) the basis function will become a simple, most probable, Flory distribution.

Three components (j=1, 2, 3) are derived with the third component (j=3) being an adjustable error term. The GPC data must be normalized and properly transformed into weight fraction versus Log₁₀ molecular weight vectors. In other words, each potential curve for deconvolution should consist of a height vector, hᵢ, where the heights are reported at known intervals of Log₁₀ molecular weight, the hᵢ have been properly transformed from the elution volume domain to the Log₁₀ molecular weight domain, and the hᵢ are normalized. Additionally, these data should be made available for the Microsoft EXCEL™ application.

Several assumptions are made in the deconvolution. Each component, j, consists of a most probable, Flory, distribution which has been convoluted with a normal or Gaussian spreading function using a parameter, σⱼ. The resulting, three basis functions are used in a Chi-square, X², minimization routine to locate the parameters that best fit the n points in hᵢ, the GPC data vector.

$${X}^{2} ( {μ}_{j} , {σ}_{j} , {w}_{j} ) = {\sum }_{i = 1}^{n} {[ {\sum }_{j = 1}^{3} \cdot {\sum }_{k = {1}^{{w}_{j}}}^{20} \cdot {M}_{i}^{2} \cdot {λ}_{j , k}^{2} \cdot {CumND}_{j , k} \cdot {e}^{- {λ}_{j , k} \cdot {M}_{i}} \cdot Δ {Log}_{10} M - {h}_{i} ]}^{2} {λ}_{j , k} = {10}^{{μ}_{j} + \frac{k - 10}{3} \cdot {σ}_{j}}$$

The variable, CumND_{j,k}, is calculated using the EXCEL™ function “NORMDIST(x, mean, standard_dev, cumulative)” with the parameters set as follows:

$$x = {μ}_{j} + ( k - 10 ) ⋆ {σ}_{j} / 3$$

$$mean = {μ}_{j}$$

$$standard dev = {σ}_{j}$$

$$cumulative = TRUE$$

Table 1 below summarizes these variables and their definitions. The use of the EXCEL™ software application, Solver, is adequate for this task. Constraints are added to Solver to insure proper minimization.

TABLE 1
Variable Definitions

| Variable | |
|---|---|
| Name | Definition |
| λ_{j, k} | Reciprocal of the number average molecular weight of most probable (Flory) |
| | distribution for component j, normal distribution slice k |
| σⱼ | Sigma (square root of variance) for normal (Gaussian) spreading function for |
| | component j. |
| wⱼ | Weight fraction of component j |
| K | Normalization term (1.0/Logₑ 10 ) |
| Mᵢ | Molecular weight at elution volume slice i |
| hᵢ | Height of log₁₀ (molecular weight) plot at slice i |
| n | Number of slices in Log molecular weight plot |
| 1 | Log molecular weight slice index (1 to n) |
| 1 | Component index (1 to 3) |
| 1. k | Normal distribution slice index |
| Δlog₁₀M | Average difference between log₁₀Mᵢ and log₁₀Mᵢ₋₁ in height vs. log₁₀M plot |

The 8 parameters that are derived from the Chi-square minimization are μ₁, μ₂, μ₃, σ₁, σ₂, σ₃, w₁, and w₂. The term w₃ is subsequently derived from w₁ and w₂ since the sum of the 3 components must equal 1. Table 2 is a summary of the Solver constraints used in the EXCEL program.

TABLE 2
Constraint summary

| Description | Constraint |
|---|---|
| Maximum of fraction 1 | w₁ < 0.95 (User adjustable) |
| Lower limit of spreading function | σ₁, σ₂, σ₃ > 0.001 (must be positive) |
| Upper limit of spreading function | σ₁, σ₂, σ₃ < 0.2 (User adjustable) |
| Normalized fractions | w₁ + w₂ + w₃ = 1.0 |

Additional constraints that are to be understood include the limitation that only μⱼ>0 are allowed, although if Solver is properly initialized, this constraint need not be entered, as the Solver routine will not move any of the μⱼ to values less than about 0.005. Also, the wⱼ are all understood to be positive. This constraint can be handled outside of Solver. If the wⱼ are understood to arise from the selection of two points along the interval 0.0<P₁<P₂<1.0; whereby w₁=P₁, w₂=P₂−P₁ and w₃=1.0−P₂; then constraining P1 and P2 are equivalent to the constraints required above for the wⱼ.

Table 3 is a summary of the Solver settings under the Options tab.

TABLE 3
Solver settings

| Label | Value or selection |
|---|---|
| Max Time (seconds) | 1000 |
| Iterations | 100 |
| Precision | 0.000001 |
| Tolerance (%) | 5 |
| Convergence | 0.001 |
| Estimates | Tangent |
| Derivatives | Forward |
| Search | Newton |
| ALL OTHER SELECTIONS | Not selected |

A first guess for the values of μ₁, μ₂, w₁, and w₂ can be obtained by assuming two ideal Flory components that give the observed weight average, number average, and z-average molecular weights for the observed GPC distribution.

$${M}_{n , GPC} = {[ {w}_{1} \cdot \frac{1}{1 {0}^{{μ}_{1}}} + {w}_{2} \cdot \frac{1}{1 {0}^{{μ}_{2}}} ]}^{- 1}$$

$${M}_{w , GPC} = [ {w}_{1} \cdot 2 \cdot {10}^{{μ}_{1}} + {w}_{2} \cdot 2 \cdot {10}^{{μ}_{2}} ] / {M}_{n , GPC}$$

$${M}_{z , GPC} = [ {w}_{1} \cdot 6 \cdot {10}^{{μ}_{1}} + {w}_{2} \cdot 6 \cdot {10}^{{μ}_{2}} ] / {M}_{w , GPC}$$

$${w}_{1} + {w}_{2} = 1$$

The values of μ₁, μ₂, w₁, and w₂ are then calculated. These should be adjusted carefully to allow for a small error term, w₃, and to meet the constraints in Table II before entering into Solver for the minimization step. Starting values for σⱼ are all set to 0.05.

### Haze

Haze is measured using a Byk Haze-Gard I. After thickness measurement, the film sample is hold against the lens at the integrating sphere end of the Haze-Gard I where it measures an Illuminant A value in accordance with ASTM D1003. This test is performed first, since it is non-destructive.

### Instrumented Dart Impact (IDI)

IDI is measured according ASTM D7192. This standard requires a probe assembly of 12.70±0.13 mm diameter with hemispherical end of the same diameter. The probe used has a 4500 N range with 1.1 mV/N sensitivity and is designed for dynamic measurements. The dart probe assembly is mounted atop a LinMot linear motor, which is an electromagnetic direct drive motor in tubular form. It has a maximum velocity of 5.4 m/s and maximum force of 1650 N.

### MD and CD Tear

MD and CD Tear was tested according to ASTM D1922-15, covering the average force required to propagate tearing through a specified length of plastic film after the tear has been started using an Elmendorf type tearing tester.

### EXAMPLES

Embodiments will be further clarified by the following examples.

TABLE 4
Process Conditions for Inventive Polymer Examples

| | Reactor 1 (Precharger) | | | | | | | Reactor 2 | | | | | | |
|---|---|---|---|---|---|---|---|---|---|---|---|---|---|---|
| | | | | Isopar E | | | | | | | Isopar E | | | |
| | | | | Solvent | | | C2 | | | | Solvent | | | C2 |
| | | Split | Tm | Flow Rate | C2 | C8 | exit | | Split | Tm | Flow Rate | C2 | C8 | exit |
| | Catalyst | [wt. %] | [° C.] | [kg/h] | [kg/h] | [kg/h] | [g/l] | Catalyst | [wt. %] | [° C.] | [kg/h] | [kg/h] | [kg/h] | [g/l] |
| A1 | / | 0 | 146 | 10.6 | 0.57 | 0.81 | 25.2 | Ziegler/Natta | 100 | 190 | 20.3 | 4.1 | 1.3 | 8.3 |
| C2 | Procatalyst 1 | 5.0 | 157 | 12.0 | 0.68 | 1.48 | 20.9 | Ziegler/Natta | 95.0 | 190 | 17.7 | 4.0 | 1.9 | 8.3 |
| B2 | Procatalyst 1 | 5.0 | 158 | 10.6 | 0.57 | 0.83 | 19.0 | Ziegler/Natta | 95.0 | 190 | 19.1 | 4.1 | 1.4 | 8.2 |
| D0 | Procatalyst 1 | 8.0 | 155 | 12.1 | 0.68 | 1.34 | 16.8 | Ziegler/Natta | 92.0 | 190 | 17.7 | 4.0 | 2.0 | 8.3 |
| E2 | Procatalyst 1 | 2.0 | 155 | 12 | 0.68 | 1.66 | 25.3 | Ziegler/Natta | 98.0 | 191 | 17.7 | 4.0 | 2.3 | 8.3 |

Referring to the process conditions in Table 4 above, the above inventive polymers were produced in a multi-reactor system. The precharger reactor, which produced the HMW component, included a catalyst system comprising the procatalyst 1 as provided below. The precharger reactor is a tubular reactor with stretched laminar flow profile. The residence time in the precharger is about 2 minutes.

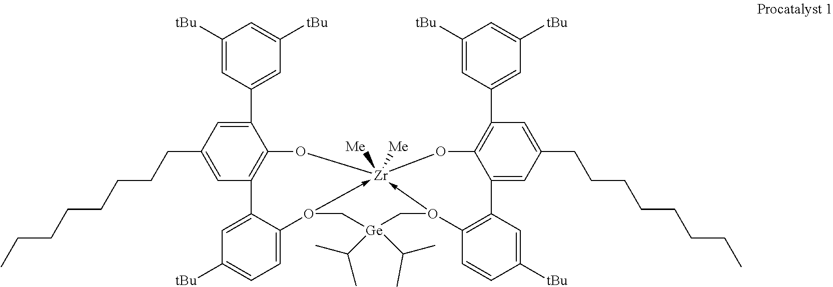

In addition to procatalyst 1, the catalyst system in the precharger includes a MMAO-7 (CAS 206451-54-9) co-catalyst and deactivator. The catalyst is provided at a feed rate of about 50 g/h and includes a concentration of 0.08 mmol/kg.

Reactor 2, which was downstream of the precharger reactor, was a CSTR reactor and included a heterogeneous Ziegler/Natta catalyst. The heterogeneous Ziegler-Natta type catalyst-premix was prepared substantially according to U.S. Pat. No. 4,612,300, by sequentially adding to a volume of ISOPAR-E, a slurry of anhydrous magnesium chloride in ISOPAR-E, a solution of EtAlCl₂ in heptane, and a solution of Ti(O-iPr)4 in heptane, to yield a composition containing a magnesium concentration of 0.20 M, and a ratio of Mg/Al/Ti of 40/12.5/3. An aliquot of this composition was further diluted with ISOPAR-E to yield a final concentration of 500 ppm Ti in the slurry. While being fed to, and prior to entry into, the polymerization reactor, the catalyst premix was contacted with a dilute solution of triethylaluminum (Et₃Al), in the molar Al to Ti ratio of 4.6 to give the active catalyst. The Ziegler-Natta catalyst was added at a concentration of 0.63 mmol/kg.

TABLE 5
Properties for Inventive Polymers

| | | | | | Conventional GPC | | | Absolute GPC | | | |
|---|---|---|---|---|---|---|---|---|---|---|---|
| | HMW | Density | MI | | Mn | Mw | Mw/ | Mn | Mw | Mz | Mz/ |
| | [wt. %] | [g/cc] | [dg/min] | I10/I2 | [g/mol] | [g/mol] | Mn | [g/mol] | [g/mol] | [g/mol] | Mw |
| A1 | 0% | 0.910 | 1.12 | 9.60 | 22,669 | 113,445 | 5.00 | — | — | — | — |
| C2 | 5% | 0.918 | 0.93 | 11.2 | 21,774 | 131,775 | 6.05 | 26,018 | 141,379 | 897,376 | 6.35 |
| B2 | 5% | 0.913 | 0.65 | 10.12 | 22,788 | 114,621 | 5.03 | — | — | — | — |
| D0 | 8% | 0.913 | 0.88 | 11.67 | 22,636 | 158,657 | 7.02 | — | — | — | — |
| E2 | 2% | 0.917 | 0.98 | 10.4 | 20,440 | 118,196 | 5.78 | 25,725 | 145,371 | 838,329 | 5.77 |

TABLE 6
Properties for Bulk and HMW fractions

| | | Bulk | | | | HMW | | | | |
|---|---|---|---|---|---|---|---|---|---|---|
| | Density | MI | Mn* | Mw* | | Density | MI | Mn* | Mw* | |
| | [g/cc] | [dg/min] | [g/mol] | [g/mol] | Mw/Mn* | [g/cc] | [dg/min] | [g/mol] | [g/mol] | Mw/Mn* |
| A1 | 0.910 | 1.12 | 22,669 | 113,445 | 5.00 | N/A | N/A | N/A | N/A | N/A |
| C2 | 0.914 | 1.76 | 20,738 | 86,170 | 4.16 | 0.880 | 0.001 | 429,923 | 998,679 | 2.32 |
| B2 | 0.914 | 1.90 | 21,379 | 84,449 | 3.95 | 0.891 | 0.000 | 235,406 | 527,856 | 2.24 |
| D0 | 0.916 | 2.44 | 20,931 | 78,993 | 3.77 | 0.880 | 0.000 | 362,520 | 1,077,747 | 2.97 |
| E2 | 0.909 | 1.04 | 20,050 | 99,115 | 4.94 | 0.880 | <0.001 | 530,720 | 1,061,241 | 2.00 |

TABLE 7

| | | | | | Shear |
|---|---|---|---|---|---|
| | | | | | Viscosity |
| | Wt. % | I2 | | Melt | (η₁₀₀) |
| Sample | HMW | (g/10 mins) | I10/I2 | Strength (cN) | (Pa · s) |
| Comparative | 0% | 0.82 | 9.1 | 3.6 | 1558.9 |
| Sample A1 | | | | | |
| B1 | 5% | 0.85 | 10.10 | 2.9 | 1286.3 |
| B2 | 5% | 0.65 | 10.12 | 4.5 | 1435 |
| B4 | 5% | 0.65 | 10.12 | 4.3 | 1561.4 |
| B5 | 5% | 0.58 | 11.13 | 5.3 | 1571.1 |
| B7 | 5% | 1.07 | 10.84 | 3.1 | 1183.5 |
| C1 | 5% | 0.58 | 14.20 | 7.1 | 1261.6 |
| D0 | 8% | 0.88 | 11.67 | 4.8 | 1254.5 |
| C2 | 5% | 0.93 | 11.18 | 5.3 | 1246.7 |
| C3 | 5% | 1.02 | 10.81 | 4 | 1224.8 |
| E2 | 2% | 0.98 | 10.40 | 3.6 | 1351.1 |
| F1 | 2% | 0.86 | 10.49 | 3.7 | 1381.3 |
| F2 | 2% | 0.82 | 10.63 | 3.9 | 1356.8 |
| F3 | 2% | 0.81 | 10.64 | 4 | 1424.5 |
| F4 | 2% | 0.84 | 10.57 | 3.9 | 1399.7 |
| F5 | 2% | 0.89 | 10.34 | 3.8 | 1395.7 |
| C2 Re-run | 5% | 0.93 | 11.18 | 4.50 | 1277.9 |
| C3 Re-run | 5% | 1.02 | 10.60 | 4.00 | 1256.47 |

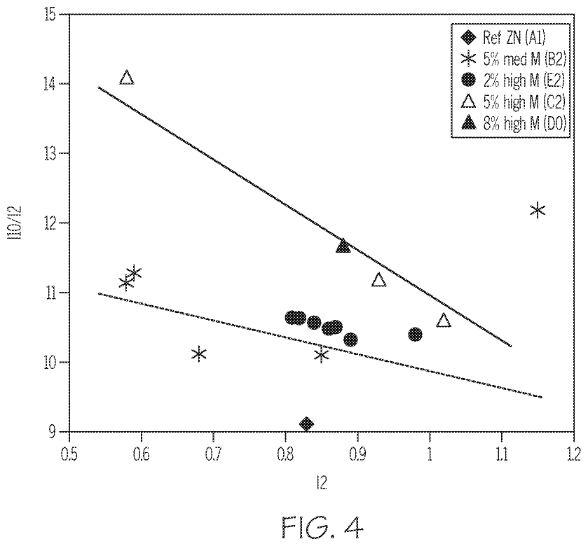

Referring to FIG. 4 and Table 7, the HMW component increased the Shear Thinning compared to similar samples with medium molecular weight. As described herein, medium molecular weight in this context corresponds to Mw values of about 500,000 g/mol. High molecular weight corresponds to Mw values of 1,000,000 g/mol. As shown in FIG. 4, the Ref ZN (A1), which does not include the HMW component, shows the lowest I₁₀/I₂. Further as shown in FIG. 4, the slope for the 5% high M (C2) is higher than the 5% med M (B2). Without being limited by theory, the increased slope is produced in part by shutting down the H₂ feed to reduce termination reactions during the polymerization process and thereby produce larger molecules.

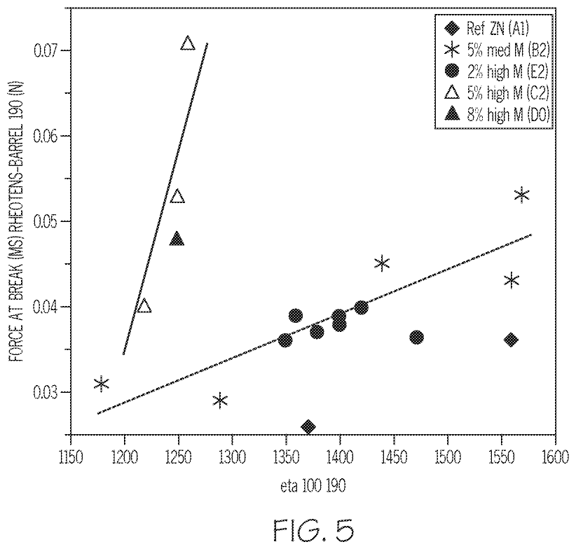

Additionally as shown in FIG. 5 and Table 7, the HMW component provides a better balance of melt strength and shear viscosity—specifically, higher MS (high free surface flow stability) at low η₁₀₀ (easy die flow). As shown in FIG. 5, the Ref ZN (A1), which does not include the HMW component, shows the lowest melt strength. Furthermore, FIG. 5 shows a clear shift for the high molecular weight samples to the upper left corner of the correlation diagram, compared to similar samples with medium molecular weight.

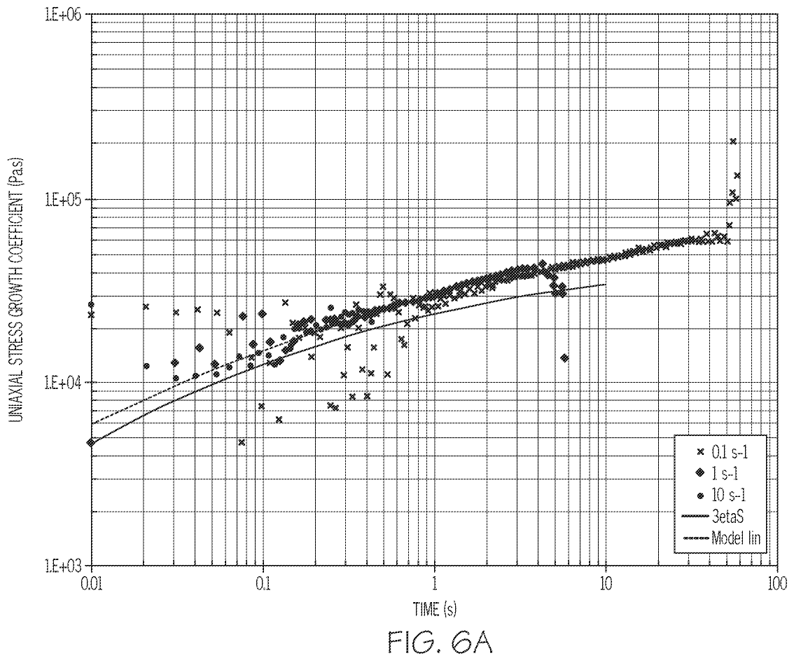

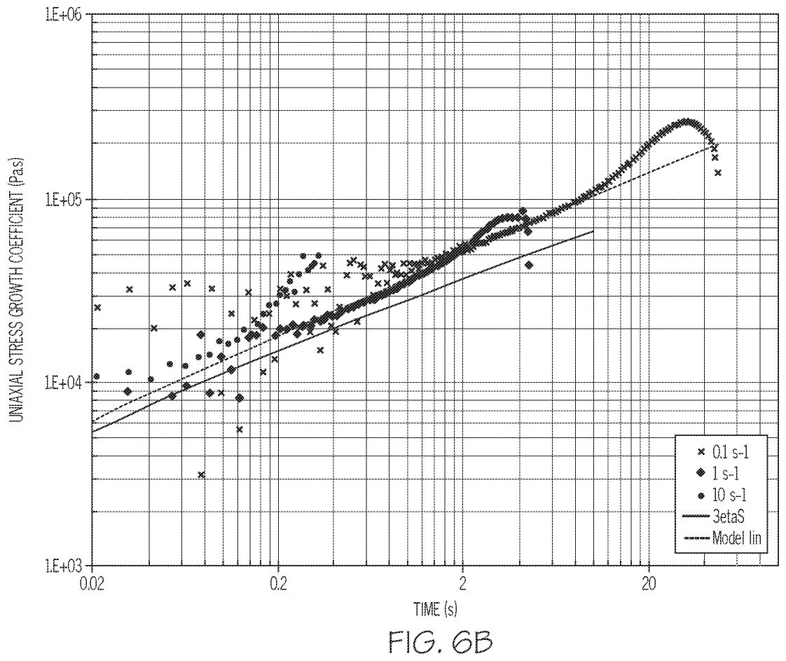

Moreover, FIGS. 6A and 6B demonstrates how the HMW component provides increased strain hardening for samples having the HMW component. FIG. 6A is a stress/time graph for Comparative Sample A1 and FIG. 6B is a stress/time graph for 5% high molecular weight sample (C1). This indicates that molecular stress resistance is changing in nature during the orientation process. For the comparative samples without the HMW component, the slope is essentially constant over time. The key difference between FIGS. 6A and 6B is the “hump” or arch in the FIG. 6B curve after a period of extended stretching. This indicates reinforcement of the intramolecular bounds compared to the reference sample of FIG. 6A, due to the presence of very large linear molecules e.g., UHMW molecules.

### Monolayer Film Fabrication

In addition to the above inventive resins 1 and 2, films were also produced from the following commercial resins produced from Dow Inc., Midland, MI:
INNATE™ ST50 is an LLDPE resin having a density of 0.918 g/cc and a melt index (12) of 0.85 dg/min;
AGILITY™ 1500 is an LDPE resin having a density of 0.920 g/cc and a melt index (12) of 0.15 dg/min; and
DOWLEX™ 2045 is an LLDPE resin having a density of 0.920 g/cc and a melt index (12) of 1.0 dg/min.

The films were made on a Collin Blown Film line using the process conditions of Table 4.

TABLE 4

| Blow Up Ratio(BUR) | 2.5 | |
|---|---|---|
| Film Gauge | 2 | mil |
| Die Gap | 80 | mil |
| Frost Line Height | 6 | in |
| Output | 12 | lbs/hr |

TABLE 5
Melt Strength (pellets) and Film Data

| | Melt | | | | |
|---|---|---|---|---|---|
| | Strength | Haze | IDI | CD Tear | MD Tear |
| | (N) | (%) | (J) | (gf) | (gf) |
| C2 | 0.053 | 10.79 | 0.48 | 1859 | 934 |
| E2 | 0.036 | 8.77 | 0.53 | 2131 | 1163 |
| INNATE | 0.036 | 10.42 | 2.4 | 953 | 666 |
| ST50 | | | | | |
| AGILITY | 0.250 | 25 | 0.28 | 255 | 221 |
| 1500 | | | | | |
| Dowlex | 0.030 | 8.2 | 0.48 | 1238 | 1120 |
| 2045 | | | | | |

As shown in the above data, inventive polymers E2 and C2 have a significant two fold increase in tear in the CD and MD directions, thereby indicating a step change improvement in the CD and MD directions. Without being limited to theory, this increased strength correlates to the inclusion of HMW resin into the bulk resin.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. A method of producing ethylene-based polymer comprising first and second polymer fractions:
reacting ethylene monomer and optionally C₃-C₁₂ α-olefin comonomer in solvent in the presence of a first catalyst in at least one initial reactor to produce the first polymer fraction reaching an exit temperature of this reaction zone below 160° C., wherein the weight averaged molecular weight (Mw) of this first polymer fraction is larger than 500,000 g/mol;
introducing the first polymer fraction, ethylene monomer, optionally C₃-C₁₂ α-olefin comonomer, solvent, at least one second catalyst to at least one agitated solution polymerization reactor;
reacting the ethylene monomer and optionally C₃-C₁₂ α-olefin comonomer in solvent in the presence of the at least one second catalyst in the at least one agitated solution polymerization reactor to produce a second polymer fraction; and
outputting effluent from the agitated solution polymerization reactor, wherein the effluent comprises the ethylene-based polymer having the first and second polymer fractions, unreacted ethylene monomer, and optionally unreacted C₃-C₁₂ α-olefin comonomer,
wherein the ethylene-based polymer comprises 0.1 to 15 wt. % of the first polymer fraction and more than 70 wt. % of the second polymer fraction, and
wherein the ethylene-based polymer has a melt index (I₂) from 0.1 to 50 g/10 mins., a density between 0.870 to 0.970 g/cc and has an Mz/Mw greater than the Mw/Mn.

2. The method of claim 1, wherein the at least one initial reactor comprises at least one tubular reactor.

3. The method of claim 2, wherein the at least one tubular reactor is a plug flow reactor.

4. The method of claim 1, further comprising reacting the effluent of the agitated solution polymerization reactor in the presence of a third catalyst in a mixer downstream of the agitated solution polymerization reactor wherein the third catalyst facilitates further reaction of the unreacted ethylene monomer and optionally any unreacted C₃-C₁₂ α-olefin comonomer to produce a third polymer fraction having a density and melt index (I₂) different from the second polymer fraction.

5. The method of claim 4, wherein the third catalyst comprises at least one molecular catalyst, at least one heterogeneous Ziegler-Natta catalyst, or combinations thereof.

6. The method of claim 4, further comprising introducing a mixer effluent from the mixer to a tubular polymerization reactor, wherein the mixer effluent comprises the ethylene-based polymer having the first, second and third polymer fractions.

7. The method of claim 1, wherein the agitated solution polymerization reactor comprises at least one continuous stirred tank reactor (CSTR), at least one loop reactor, or combinations thereof.

8. The method of claim 1, wherein the first catalyst and the second catalyst comprise different compositions.

9. The method of claim 1, wherein the agitated solution polymerization reactor comprises an exit temperature of at least 180° C., preferably at least 190° C., or most preferably at least 200° C.

10. The method of claim 1, wherein the first catalyst comprises a molecular catalyst.

11. The method of claim 1, wherein the second catalyst comprises at least one molecular catalyst, at least one heterogeneous Ziegler-Natta catalyst, or combinations thereof.
